(19) United States
(12) Patent Application Publication
(10) Pub. No.: US 2013/0263694 A1
(43) Pub. Date: Oct. 10, 2013

(54) CAM

(71) Applicant: Schaeffler Technologies AG & Co. KG, Herzogenaurach (DE)

(72) Inventors: Oliver Witter, Westhausen (DE); Michael Kress, Lonnerstadt (DE)

(21) Appl. No.: 13/835,389

(22) Filed: Mar. 15, 2013

(30) Foreign Application Priority Data
Mar. 23, 2012 (DE) 102012204727.1

(51) Int. Cl. F16H 25/08

(52) U.S. Cl. CPC F16H 25/08
USPC 74/569

(57) ABSTRACT

According to the invention this object is attained by a rocker arm for actuating at least one gas exchange valve of an internal combustion engine having an elongated lever body with a floor and with side walls angled away therefrom, wherein a first end section of the lever body has a cup formed in the floor for a support element, and in that a section near the center is provided with a cam engagement surface and in that a second end section of the lever body has a bottom contact surface for a valve stem end of the gas exchange valve, wherein a crossbar extends between the section near the center and the second end section, and wherein the bottom contact surface for the valve stem end has a first stamping toward the top side of the rocker arm for a direct fine enclosure of the valve stem end, and wherein the crossbar has a second stamping whose shape is matched to the valve stem end.

### FIELD OF THE INVENTION

The invention concerns a rocker arm for actuating a gas exchange valve of an internal combustion engine.

### BACKGROUND OF THE INVENTION

In internal combustion engines, rocker arms are located in a valve train as transmission elements between cams and the gas exchange valves to be actuated. Rocker arms consist of a lever body that is supported at one of its ends on a support element and with its other end engages, through a contact surface, the gas exchange valve to be opened. In a section of the lever body near the center, a cam pickup surface is provided on which a cam of a camshaft runs during operation of an internal combustion engine, causing a pivoting motion of the rocker arm. The cam pickup surface can be implemented as a sliding surface or as a cam roller.

A rocker arm for actuating a gas exchange valve of an internal combustion engine is known from DE 10 2008 029 333 A1. At one end, the rocker arm has an oval opening that encompasses a valve stem end of the gas exchange valve. In addition, the rocker arm provides a cam roller in a section near the center.

WO2011/157499 A1 discloses a rocker arm that has a cam roller supported on an axle pin by means of a needle roller and cage assembly. A contact surface for a valve stem end of the gas exchange valve is provided at one end of the rocker arm. Side bars are provided in the region of the contact surface to guide the rocker arm on the valve stem end.

### SUMMARY OF THE INVENTION

The object of the present invention is to provide a rocker arm that can be manufactured economically and that ensures adequate stiffness.

According to the invention this object is attained by a rocker arm for actuating at least one gas exchange valve of an internal combustion engine having an elongated lever body with a floor and with side walls angled away therefrom, wherein a first end section of the lever body has a cup formed in the floor for a support element, and in that a section near the center is provided with a cam engagement surface and in that a second end section of the lever body has a bottom contact surface for a valve stem end of the gas exchange valve, wherein a crossbar extends between the section near the center and the second end section, and wherein the bottom contact surface for the valve stem end has a first stamping toward the top side of the rocker arm for a direct fine enclosure of the valve stem end, and wherein the crossbar has a second stamping whose shape is matched to the valve stem end.

In the rocker arm according to the invention, a first stamping is provided on the contact surface for the valve stem end. A fine enclosure that serves to guide the valve stem end is formed on the lateral ends of the contact surface by the first stamping. The fine enclosure permits precise guidance of the valve stem end.

The second stamping in the crossbar makes it possible for contact between the valve stem end and the lever body to be avoided during pivoting motions of the rocker arm. The necessary stiffening of the rocker arm is ensured by the crossbar, which in turn results in increased strength of the rocker arm. The advantage of this is that the shortest possible construction of the rocker arm can be achieved.

The stamping can be an embossing, for example. The shape of the stamping is designed to be complementary to the shape of the valve stem end. Preferably the stamping is implemented as a cylindrical molding.

In a preferred embodiment of the invention, the stamping is provided on the side facing away from the section near the center. This arrangement allows for the necessary clearance between the crossbar and the valve stem end.

According to one embodiment of the invention, the second end section has side bars that are provided for coarse enclosure of the valve stem end and have a slightly larger clear width than the clear width of the first stamping. Additional valve guidance of the valve stem end is ensured by means of the coarse enclosure. The side bars can be designed as a single piece with the second end section. It is also possible to weld the side bars on or to join them to the second end section using another connection method.

It is preferred for the side bars to extend in a curve from the side walls to the crossbar. The coarse enclosure formed by the side bars thus extends below the fine enclosure.

Preferably the second end section of the lever body has an H-shaped profile when viewed in cross-section. The H-shaped profile permits a narrow construction of the rocker arm since it eliminates double folds of the rocker arm that necessitate a wider construction, such as in a W-shaped profile, for example. However, it is also possible to provide a W-shaped or U-shaped profile.

In one embodiment, the cam pickup surface is implemented by a cam roller, wherein the section near the center has a recess in the floor that serves to accommodate the cam roller. The recess in the floor creates the necessary free space for the cam roller so that rotary motion of the cam roller is possible.

Preferably, the lever body is either produced by stamping and forming techniques from a sheet metal material, by extrusion molding, or by deep-drawing. However, other materials and manufacturing methods are also possible.

### BRIEF DESCRIPTION OF THE DRAWINGS

An exemplary embodiment of the invention is explained below using three figures. They show:

FIG. 1 a rocker arm according to the invention in a perspective view,

FIG. 2 a longitudinal cross-section through the rocker arm according to the invention, and

FIG. 3 a portion of a rocker arm according to the invention in a perspective view.

### DETAILED DESCRIPTION OF THE DRAWINGS

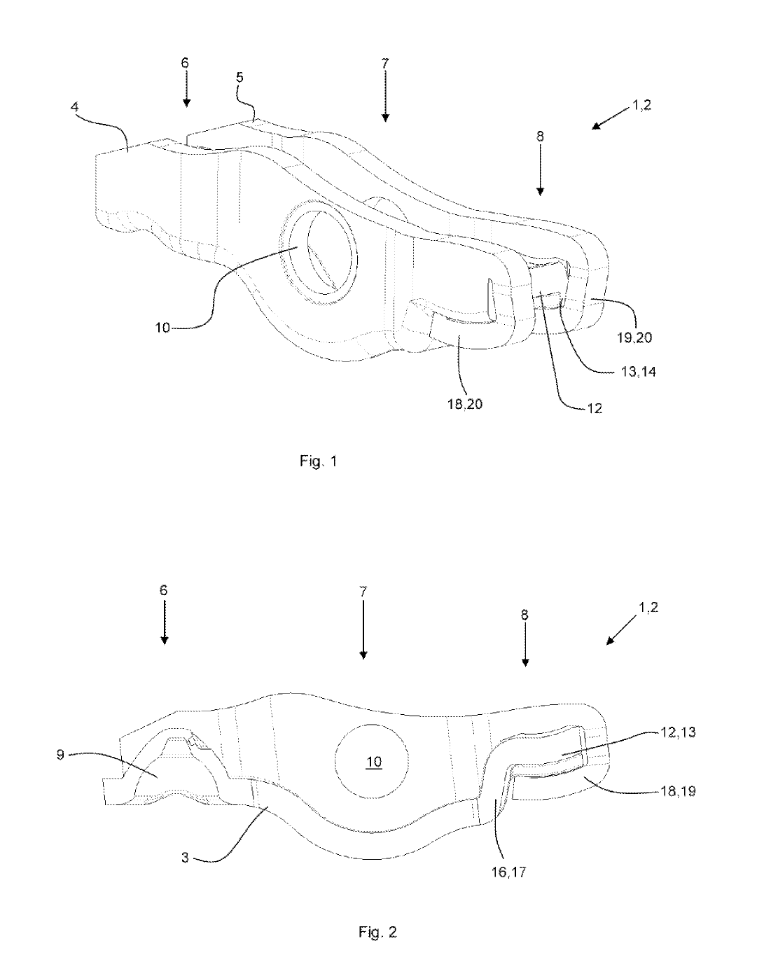

FIGS. 1 through 3 each show different views of a rocker arm 1 according to the invention. The rocker arm 1 has an elongated lever body 2, which has a floor 3 and side walls 4, 5 angled away therefrom. The floor 3 and the side walls 4, 5 form an H-shaped profile when viewed in cross-section. Moreover, the lever body 2, which is made of a sheet metal material, is divided into a first end section 6, a section 7 near the center, and a second end section 8.

Formed in the part of the floor 3 running along the first end section 6 is a cup 9, which rises between the side walls 4, 5. The cup 9 provides support on a support element that is not shown.

In the region of the section 7 near the center, each of the side walls 4, 5 has a bore 10 serving to support a cam roller that is not shown. The cam roller that is not shown defines a cam pickup surface. A recess 11 designed with a rectangular outer contour is provided in the part of the floor 3 running along the section 7 near the center.

A contact surface 12 for a valve stem end, not shown, of a gas exchange valve is provided on the part of the floor 3 running along the second end section 8 of the lever body 2. The contact surface 12 has a first stamping 13, which is provided towards the top of the rocker arm 1. A fine enclosure 14, 15 for a valve stem end, not shown, is formed on the lateral ends of the contact surface 12 by the first stamping 13. The fine enclosure 14, 15 is matched to the valve stem end in this design.

A crossbar 16 that is provided between the side walls 4, 5 extends between the second end section 8 and the section 7 near the center. The crossbar 16 has a second stamping 17, which is implemented as a cylindrical molding, on the side facing away from the section 7 near the center. The stamping 17 makes it possible for adequate clearance of the contact surface relative to the gas exchange valve, not shown, to be present during pivoting motions of the rocker arm 1.

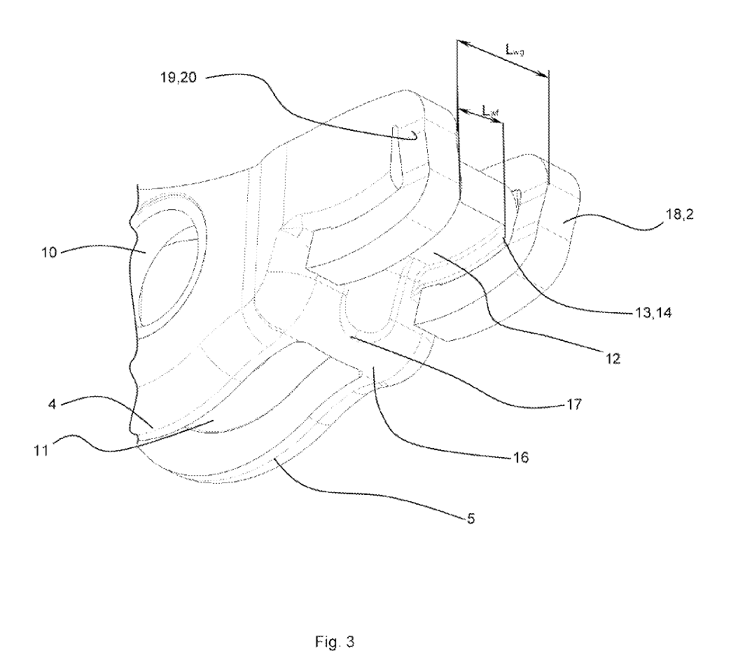

As is evident from FIGS. 1 and 3, the rocker arm 1 has side bars 18, 19 in the region of the second end section 8. The side bars 18 start at the side walls 4, 5 and extend in a curve to the crossbar 16. In this design, the side bars 18, 19 form a coarse enclosure 19 for a valve stem end that is not shown.

The spacing between the side bars 18, 19 defines a clear width L_{wg} of the coarse enclosure 20. The spacing of the fine enclosure 14, 15 defines a clear width L_{wf}. As is evident from FIG. 3, the clear width L_{wg} of the coarse enclosure 20 is slightly larger than the clear width L_{wf} of the fine enclosure 14, 15.

### LIST OF REFERENCE CHARACTERS

1 rocker arm

2 lever body

3 floor

4 side wall

5 side wall

6 first end section

7 section near the center

8 second end section

9 cup

10 bore

11 recess

12 contact surface

13 first stamping

14 fine enclosure

15 fine enclosure

16 crossbar

17 second stamping

18 side bar

19 side bar

20 coarse enclosure

L_{wg} clear width of the coarse enclosure

L_{wf} clear width of the fine enclosure

1. Rocker arm for actuating at least one gas exchange valve of an internal combustion engine having an elongated lever body (2) with a floor (3) and with side walls (4,5) angled away therefrom, wherein a first end section (6) of the lever body (2) has a cup (9) formed in the floor (3) for a support element, wherein a section (7) near the center is provided with a cam engagement surface, wherein a second end section (8) of the lever body (2) has a bottom contact surface (12) for a valve stem end of the gas exchange valve, and wherein a crossbar (16) extends between the section (7) near the center and the second end section (8), characterized in that the bottom contact surface (12) for the valve stem end has a first stamping (13) toward the top side of the rocker arm for a direct fine enclosure (14, 15) of the valve stem end, and wherein the crossbar (16) has a second stamping (17) whose shape is matched to the valve stem end.

2. Rocker arm according to claim 1, wherein the second stamping (17) is provided on the side facing away from the section (7) near the center.

3. Rocker arm according to one of the preceding claims, wherein the second end section (8) has side bars (18, 19) that are provided for coarse enclosure (20) of the valve stem end and have a slightly larger clear width (L_{wg}) than the clear width (L_{wf}) of the first stamping (13).

4. Rocker arm according to claim 3, wherein the side bars (18, 19) extend in a curve from the side walls (4, 5) to the crossbar (16).

5. Rocker arm according to one of the preceding claims, wherein the second end section (8) of the lever body (2) has an H-shaped profile when viewed in cross-section.

6. Rocker arm according to one of the preceding claims, wherein the cam pickup surface is implemented by a cam roller, and wherein the section (7) near the center has a recess (11) in the floor (3) that serves to accommodate the cam roller.

7. Rocker arm according to one of the preceding claims, wherein the lever body (2) is either produced by stamping and forming techniques from a sheet metal material, by extrusion molding, or by deep-drawing.
